(19) United States
(12) Patent Application Publication
(10) Pub. No.: US 2002/0144879 A1
(43) Pub. Date: Oct. 10, 2002

(54) Method and apparatus for relieving stress in an electrophoresis gel slab

(76) Inventors: N. Leigh Anderson, Washington, DC (US); Jack Goodman, Lusby, MD (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 09/978,574

(22) Filed: Oct. 18, 2001

Related U.S. Application Data
(60) Provisional application No. 60/281,000, filed on Apr. 4, 2001.

(51) Int. Cl. B65G 47/36; B65G 47/22; B65G 47/24; G01N 27/26

(52) U.S. Cl. 198/345.1; 204/462; 204/463; 204/613

(57) ABSTRACT

A gel relaxer device is provided for relieving stress in an electrophoresis gel between clamping surfaces of a gel clamp. The device includes a pair of operating arms having a gel gripping surface and a clamping actuating surface. The operating arms move toward each other to enable the gripping surfaces to grip and support an electrophoresis gel suspended by a gel clamp. The actuating surfaces of the arms engage the clamping jaws of the gel clamp to open the jaws to allow the gel to relax and assume its normal position and orientation. The operating arms are then separated to allow the gel clamp to again close and clamp the gel. The gel and gel clamp can then be transported to a selected processing stage.

### CROSS-REFERENCE TO RELATED APPLICATION

This application claims the benefit of U.S. provisional application Ser. No. 60/281,000 filed Apr. 4, 2001 for “Automated Electrophoresis Gel Staining, Imaging and Cutting Apparatus and Method”, which is hereby incorporated by reference in its entirety.

### FIELD OF THE INVENTION

The present invention is directed to a method and apparatus for relieving stress in an electrophoresis gel slab caused by expansion or contraction of the gel slab. More particularly, the invention is directed to a method apparatus for supporting an electrophoresis gel slab in a gel clamp and releasing tension in the gel between the clamping surfaces of a gel clamp.

### BACKGROUND OF THE INVENTION

The separation of proteins and other macromolecules is often carried out by a slab gel electrophoresis separation in which the sample migrates through the gel slab, to a point determined by the molecular weight of the molecules in the sample. The gel acts as a sieve to separate the molecules according to their molecular weight under the influence of an electric potential.

Isoelectric focusing (IEF) is an electrophoretic technique for the analysis, separation and purification of various biological materials. Since many of the complex molecules of biological interest are amphoretic in nature, they are typically amenable to IEF separation.

Isoelectric separation is a known process that has been used for many years. An isoelectric focusing gel, such as an acrylamide gel, is placed or polymerized in a tube having open ends. Each open end is positioned in a bath containing a buffer solution. One buffer solution is typically a sodium hydroxide solution to contact one end of the gel tube. The other buffer solution is typically a phosphoric acid solution at the opposite end of the tube to produce a pH gradient between the two ends of the tube. When current is applied, the two buffer solutions, together with ampholytes incorporated into the gel composition or titratable gel monomers incorporated into the gel, provide an electric potential through the gel along the length of the tube. The sample to be analyzed is applied to a top end of the gel in a tube and an electric current is applied to an electrode in each of the buffer solutions. The molecules in the sample migrate through the gel under the influence of the electric potential until they reach their isoelectric point.

The separation of macromolecules, and particularly proteins, often is carried out by a two-dimensional electrophoresis separation process. The two-dimensional electrophoresis separation typically involves the sequential separation by isoelectric focusing of a sample in a gel tube followed by slab gel electrophoresis. The isoelectric focusing process is often referred to as first dimension separation. Slab gel electrophoresis, often referred to as second dimension separation, utilizes an electrophoresis gel molded between two glass plates. A gel strip or cylinder in which the protein sample has been resolved by the first dimension isoelectric focusing is placed along one edge of the slab gel. The opposite ends of the gel slab are immersed in a buffer solution and an electric current is applied between the ends to provide an electric potential through the gel slab. The proteins are then allowed to migrate through the gel slab under an applied voltage.

Charged detergents, such as sodium dodecyl sulfate, contained in the slab gel bind to the protein molecules. The detergents tend to unfold the protein molecules into rods having a length proportional to the length of the polypeptide chain and thus proportional to the molecular weight of the polypeptide. A protein complexed with a charged detergent is highly charged, which causes the protein-detergent complex to move in an applied electric field. When the slab gel, such as a polyacrylamide gel, functions as a sieve, the movement of the longer and higher molecular weight molecules is retarded compared to the shorter, lower molecular weight molecules.

Electrophoresis separation is generally labor intensive since numerous samples are run simultaneously. In the first dimension separation, the gel tubes are prepared and placed in a suitable tank of buffer solutions. The protein samples are then manually placed on the end of a gel tube. When hundreds of protein samples are prepared daily for isoelectric focusing, the manual steps significantly increase the time requirements for performing the first dimension separation. Accordingly, there is a need in the industry for improved methods and devices for conducting first dimension isoelectric focusing.

Various devices have been proposed for handling and manipulating the gel status between workstations. The gels are soft and pliable and can require careful handling to avoid tearing or damaging the gels. The gels are transferred to various staining baths to stain the proteins so that the location of the proteins within the gel can be visualized. The staining reagents as well as other reagents used process the gel can result in the expending or contracting. Accordingly, efforts must be taken to compensate for the dimensional changes in gel desiring the processing steps.

### SUMMARY OF THE INVENTION

The present invention is directed to a method and apparatus for handling and manipulating an electrophoresis gel slab. More particularly, the invention is directed to a method and apparatus for relieving stress in an electrophoresis gel caused by contraction or expansion of the gel during processing of the gel.

The method and apparatus of the invention are preferably used in conjunction with an automated assembly for transferring a second dimension electrophoresis gel slab between various processing stations. In particular, the apparatus is particularly suitable as a subassembly for an automated gel staining assembly for staining, marking or labeling the proteins in the electrophoresis gel so that the proteins or other macromolecules can be visualized and analyzed. The gel slab is typically a second dimension electrophoresis gel that is used for the separation of macromolecules such as proteins.

In one embodiment of the invention the electrophoresis gel is handled and manipulated by a gel clamp where the clamp has opposing clamping jaws that are able to grip the gel along a longitudinal edge without damaging the gel. The clamp is able to suspend the gel vertically and can be coupled to a suitable robotic assembly for transporting the gel clamp with the associated gel between workstations. During the various processing stages and treatment with the various reagents, the gel can contract or expand. The gel can exhibit some distortion along the edge between the clamping jaws as the gel expands or contracts. The clamping pressure when sufficient to grip the gel and suspend the gel vertically, prevents movement of the gel between the clamping jaws, which causes the gel to distort and form wrinkles. Accordingly, a primary aspect of the invention is to provide a method and apparatus for relieving the stress in a gel and to allow the gel to expand or contract as needed between the clamping surfaces of the clamp.

Another aspect of the invention is to provide a method and apparatus for enabling an electrophoresis gel to relax and to relieve stresses produced in the gel as a result of the processing stages.

A further aspect of the invention is to provide a method and apparatus for relieving stress in an electrophoresis gel slab in an area held in a fixed position by a clamping force.

Another aspect of the invention is to provide a method and apparatus for opening the jaws of a gel clamp to allow the gel to relax and conform to a natural shape and dimension.

Still another aspect of the invention is to provide a method and apparatus for relieving stress in a gel secured between opposing jaws of a gel clamp by supporting the gel and opening the jaws of the gel clamp to remove the clamping pressure.

A further aspect of the invention is to provide a method for relieving stress in a gel coupled to a gel clamp by releasing the clamping pressure on the gel while maintaining the position of the gel with respect to the gel clamp.

Another aspect of the invention is to provide a method for relieving stress in a gel coupled to a gel clamp by supporting the gel and momentarily releasing the clamping pressure on the gel.

A further aspect of the invention is to provide a method and apparatus for supporting an electrophoresis gel and a gel clamp and allowing the gel to relax between clamping surfaces of the clamp.

Still another aspect of the invention is to provide a method and apparatus for supporting an electrophoresis gel and a gel clamp, supporting the gel, opening the clamp for sufficient time to allow the gel to assume a normalized position and closing the gel clamp to secure the gel.

Another aspect of the invention is to provide an automated method and apparatus for opening the clamping jaws of a gel clamp at predetermine intervals and for a time sufficient to relieve stress in the gel and prevent distortion of the gel caused by expansion or contraction of the gel.

A further aspect of the invention is to provide an automated apparatus for supporting an electrophoresis gel while relieving the clamping pressure on the gel by a gel clamp.

Another aspect of the invention is to provide an apparatus for holding a gel in a fixed position and temporarily opening the clamping jaws of a gel clamp used to support the gel.

Still another aspect of the invention is to provide an apparatus having a pair of operating arms for relieving stress in a gel suspended by a gel clamp, where the arms grip the gel and relieve the clamping pressure between the clamping surfaces.

A further aspect of the invention is to provide an apparatus having a pair of arms for relieving stress in a gel suspended by a gel clamp, where the arms are movable to a position to grip the gel and contact the gel clamp with sufficient force to open the clamping jaws while holding the gel in place.

Another aspect of the invention is to provide an apparatus for releasing a gel from a gel clamp where the apparatus includes a pair of arms to automatically engage the clamping jaws of the gel clamp to open the jaws and allow the gel to fall free from the clamp.

The aspects of the invention are basically attained by an apparatus for releasing an electrophoresis gel from a gel clamp. The gel clamp has a first clamping jaw and a second clamping jaw. The second clamping jaw is movable with respect to the first clamping jaw for clamping the gel between the first clamping jaw and the second clamping jaw. The apparatus comprises a first operating arm that has an actuating area for engaging the first clamping jaw of the gel clamp, and a second operating arm that has an actuating area for engaging the second clamping jaw of the gel clamp. The first operating arm is movable with respect to the second operating arm between a disengaged position and an actuating position to open the first clamping jaw and the second clamping jaw to release the gel.

The aspects of the invention are further attained by providing an apparatus for relieving tension in an electrophoresis gel supported by a gel clamp. The gel clamp has a first clamping jaw and a second clamping jaw. The apparatus comprises a first movable operating arm which has a gripping surface and an actuating surface, and a second movable operating arm opposing the first operating arm which has a gripping surface and an actuating surface. The first operating arm and the second operating arm are movable between a disengaging position spaced from the gel and gel clamp and a clamping position. The gripping surfaces of the first operating arm and the second operating arm grip the gel and the actuating surfaces engage the gel clamp to open the first clamping jaw and the second clamping jaw to release the gel.

The aspects of the invention are yet further attained by providing a method for relieving tension in an electrophoresis gel suspended by a gel clamp. The gel clamp has a first clamping jaw and a second clamping jaw. The method comprises the steps of gripping the electrophoresis gel with a gel handling assembly to apply sufficient force to suspend the gel in a vertical orientation, opening the gel clamp while gripping and suspending the gel by the gel handling assembly, closing the gel clamp onto the gel, and releasing the gel from the gel handling assembly.

The aspects of the invention are still further attained by a method of processing an electrophoresis gel comprising the steps of: suspending the gel by a gel clamp, contacting the gel with at least one treating liquid, and gripping the gel with a gel handling assembly with sufficient force to suspend the gel in a vertical orientation. The gel clamp has a first clamping jaw and a second clamping jaw. The gel is clamped between respective clamping surfaces of the first clamping jaw and the second clamping jaw. The first and second clamping jaws of the gel clamp are opened while suspending the gel by the gel handling assembly for sufficient time to relieve tension in the gel caused by shrinking or expansion of the gel. The first and second clamping jaws of the gel clamp are closed to grip the gel and the gel is released from the gel handling assembly.

The objects, advantages and salient features of the invention will become apparent to one skilled in the art in view of the following detailed description of the invention in conjunction with the annexed drawings which form a part of this original disclosure.

### BRIEF DESCRIPTION OF THE DRAWINGS

The following is a brief description of the drawings, in which:

FIG. 1 is a perspective view of the automated assembly in one embodiment of the invention showing a robotic arm for transporting an electrophoresis gel and gel clamp and the gel relaxing device;

FIG. 2 is a top view of the gel relaxing device of the embodiment of FIG. 1;

FIG. 3 is a cross-sectional in view taken a long line 3-3 of FIG. 2;

FIG. 4 is an exploded front view of the apparatus and gel clamp showing the liquid treating tank in cross section;

FIG. 5 is a front view in partial cross section showing the apparatus assembled on a liquid treatment tank;

FIG. 6 is a cross-sectional view of the apparatus taken along line 6-6 of FIG. 2;

FIG. 7 is a cross-sectional view of the apparatus taken along line 7-7 of FIG. 2;

FIG. 8 is a partial end view of the apparatus showing the gel clamp and gel positioned above the apparatus in a position for coupling with the apparatus;

FIG. 9 is an end view of the apparatus showing the gel clamp in the operating position in the apparatus;

FIG. 10 is an end view of the apparatus showing the clamping arms engaging the gel and gel clamp;

FIG. 11 is an end view showing the arms of the apparatus gripping the gel and opening the jaws of the gel clamp;

FIG. 12 is an end view of the apparatus showing the operating arms in the retracted position and the gel and gel clamp being removed from the apparatus;

FIG. 13 is a perspective view of the gel clamp in an open position in one embodiment in the invention;

FIG. 14 is a perspective view of the gel clamp with the clamping jaws closed on the electrophoresis gel;

FIG. 15 is a perspective view showing the gel being supported below the gel clamp and the jaws of the gel clamp being opened to relieve stress and allow the gel to relax;

FIG. 16 is a perspective view of the gel clamp in the clamping position with the operating arms releasing the gel;

FIG. 17 is a cross-sectional end view of the apparatus in a second embodiment of the invention showing the operating arms in the open position and the gel clamp in the operating position;

FIG. 18 is a cross-sectional end view of the embodiment of FIG. 17 showing the operating arms engaging the gel and gel clamp;

FIG. 19 is a cross-sectional end view of the apparatus of FIG. 17 showing the operating arms gripping the gel and opening the clamping jaws of the gel clamp;

FIG. 20 is a cross-sectional end view of the apparatus in a third embodiment of the invention showing the operating arms in the open position; and

FIG. 21 is a cross-sectional end view of the apparatus of FIG. 20 showing the operating arms engaging the gel clamp and opening the jaws to release the gel.

### DETAILED DESCRIPTION OF THE INVENTION

The present invention is directed to a method and apparatus for manipulating a gel material. More particularly, the invention is directed to a method and apparatus for supporting an electrophoresis gel by a gel-handling device and reducing distortion of the gel in the gel-handling device.

The apparatus of the invention is preferably an automated apparatus for use in conjunction with various processes for electrophoresis separation of macromolecules. Electrophoresis separation typically uses a two-dimension separation process. In the first dimension separation, the sample is placed at one end of a tube containing an acrylamide gel. The ends of the tube are placed in contact with a buffer solution to provide a pH gradient along the length of the tube and a sample containing the macromolecules is placed at one end of the tube. An electric current is applied through the length of the gel causing the macromolecules to migrate through the gel. The gel is then removed from the tube and placed along the edge of a gel slab that is supported between two sheets of glass. The gel slab supported between the sheets of glass is often referred to as a gel pack or a gel cassette. Opposite ends of the gel slab are then contacted with a buffer solution and an electric current is supplied through the ends of the gel to cause the molecules to migrate at different rates through the gel slab. The gel acts as a sieve to separate the molecules according to their molecular weight.

The second dimension gel is typically an acrylamide gel having a thickness of about 2 to 5 millimeters. The resulting gels are separated from the glass plates and stained to visualize the separated macromolecules. The gel is soft and pliable and can be damaged easily through the processing and handling steps. According to the present invention, the gels are handled by gripping the edge of the gel with a gel clamp so that the gels can be transported between the various workstations where the gels are treated with various reagents, such as stains, fixing solutions and washing solutions. During the various processing steps of the gel, the gel can shrink or expand. The change in dimension of the gel can result in distortion of the gel when the gel is clamped by the gel clamp.

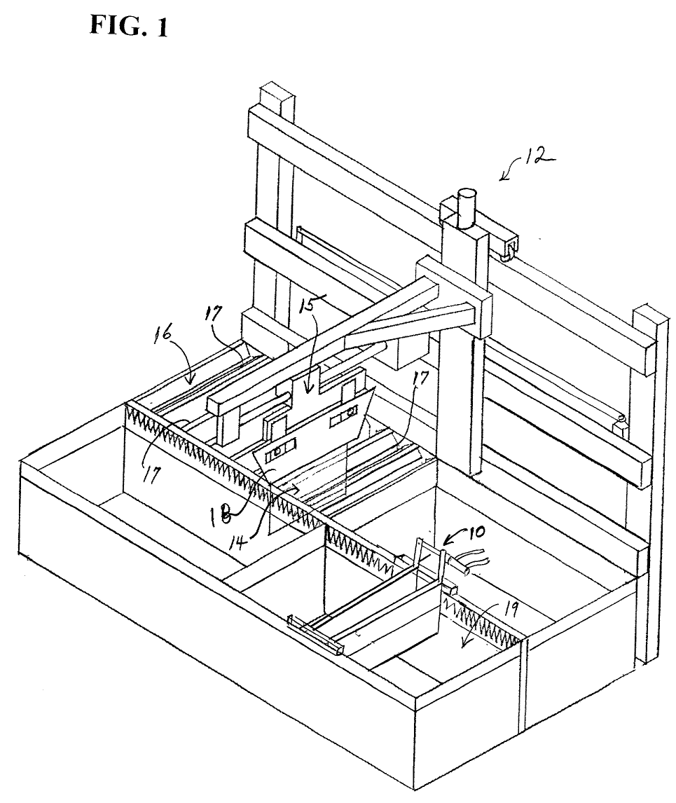

Referring to FIG. 1, apparatus 10 is constructed to release the clamping pressure on the gel and is intended primarily for use in conjunction with an electrophoresis gel processing apparatus 12. In preferred embodiments, the entire assembly is computer operated to transfer a gel 14 to selected processing stations 16. In one embodiment, processing station 16 includes a series of tanks 17 containing various staining reagents for staining proteins or other macromolecules in a gel slab as known in the art. As shown in FIG. 1, apparatus 10 is used in conjunction with a tank 19 dimensioned to contain a treating, stabilizing or wash liquid and to receive an electrophoresis gel 14. A computer controlled robotic arm 15 that is movable in three dimensions is provided to transport a gel clamp 18 with a captured gel 14 between the processing stations. In one embodiment, tank 19 can include a plurality of chambers for receiving several gels 14.

Computer controlled robotic arm 15 includes two movable operating arms that are able to engage and suspend gel clamp 18. Robotic arm 15 is movable along a vertical axis to lift gel clamp 18 and its associated gel 14 from one tank and to lower the gel clamp and gel to another tank. Robotic arm 15 is also mounted on a boom that is able to move along a track in a longitudinal direction with respect to assembly 12. The robotic arm is generally movable along the boom in a transverse direction with respect to the assembly to enable the robotic arm to move a gel clamp to any selected location within the assembly.

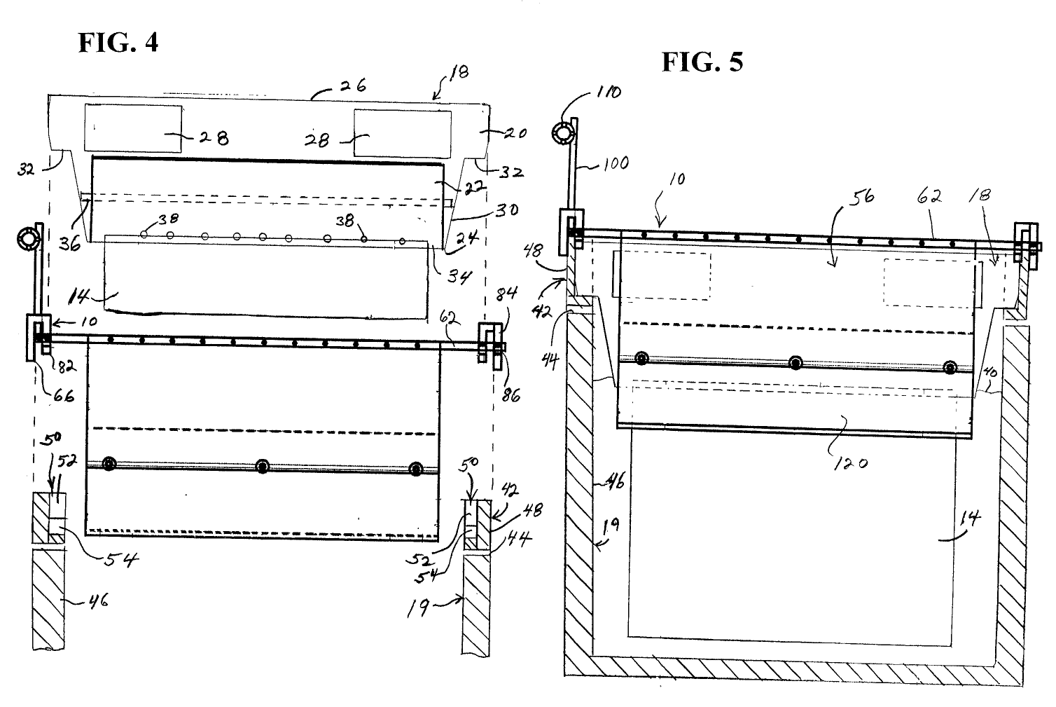

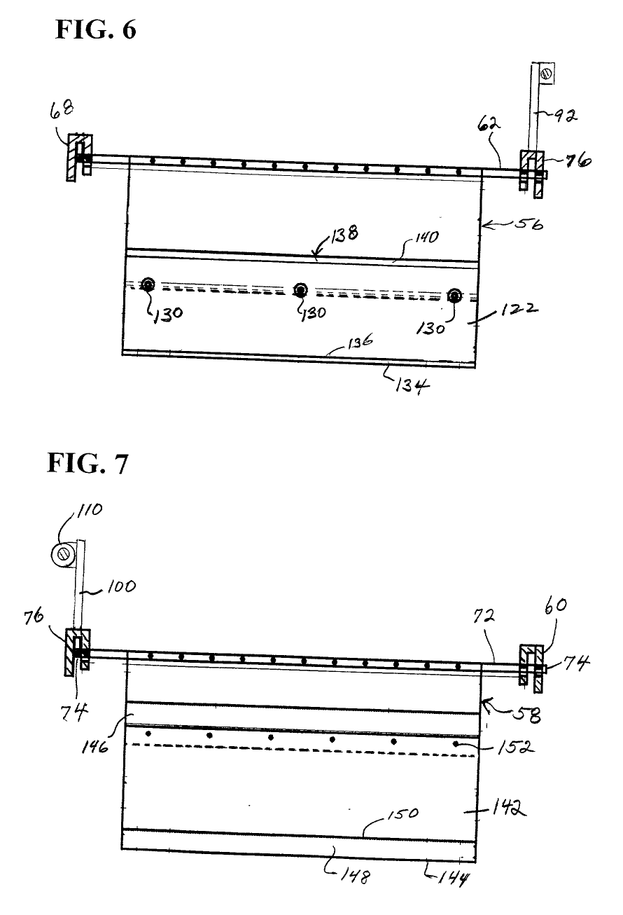

In one embodiment, gel 14 is supported by gel clamp 18. As shown in FIG. 4, gel clamp 18 includes a first clamping jaw 20 and a second clamping jaw 22. Second clamping jaw 22 is movable with respect to first clamping jaw 20 to provide a clamping pressure on gel 14. In the illustrated embodiments, the clamping jaws pivot with respect to each other.

First clamping jaw 20 as shown in FIG. 4 includes a substantially straight bottom end 24 forming a gripping surface. First clamping jaw 20 has a top end 26 and a pair of apertures 28 adjacent top end 26 for coupling to robotic assembly 15. First clamping jaw 20 is provided with opposite side edges 30 having a shoulder 32. Shoulder 32 has a width to engage a support for supporting gel clamp 18 and gel 14.

Second clamping jaw 22 has a bottom end 34 defining a clamping surface cooperating with the clamping surface of first clamping jaw 20. As is shown in FIG. 4, second clamping jaw 22 has a height substantially less then the height of first clamping jaw 20. In the embodiment illustrated, first clamping jaw 20 includes a rib 36 spaced from bottom edge 24 and extending substantially parallel thereto. Rib 36 has a dimension sufficient to define a fulcrum to enable second clamping jaw 22 to pivot with respect to first clamping jaw 20.

Bottom end 24 of first clamping jaw 18 and bottom end 34 of second clamping jaw 22 are provided with a plurality of space apart magnets 38. Magnets 38 on first clamping jaw 20 are aligned with a respective magnet on second clamping jaw 22 to attract the clamping surfaces of gel clamp 18 together and to bias second clamping jaw 22 to a clamping position. In one embodiment of the invention, the opposing clamping surfaces of first clamping jaw 20 and second clamping jaw 22 include a friction enhancing texture to effectively grip gel 14 and prevent gel 14 from slipping from the clamping surfaces. In one embodiment, the clamping surfaces include a fine grit sandpaper to provide a slip resistant surface.

In one embodiment of the invention, apparatus 10 is used in conjunction with tank 19 that can contain a treating liquid 40. Tank 12 in this embodiment includes a supporting frame 42 positioned along a top edge of a side wall 46 of tank 12. Supporting frame 42 includes opposite side rails 48 that are spaced apart a distance to support gel clamp 18. In a preferred embodiment, side rails 48 have an opposing recess 50 to receive shoulder 32 of gel clamp 18. Each recess 50 has a generally V-shaped top end defined by incline surfaces 52. Incline surfaces 52 converge to a slot 54 having a width to receive first clamping jaw 20 for supporting gel clamp 18 above tank 19. In the embodiment illustrated, frame 42 is a separate element from tank 19. In one embodiment, frame 42 is coupled to an agitating assembly for agitating gel clamp 18 and the gel 14 in the treating liquid 40. In an alternative embodiment, frame 42 can be integrally formed with tank 12 so that recesses 50 are formed in side wall 46 of tank 12.

In a first embodiment, apparatus 10 is coupled to side rails 48 of frame 42. Alternatively, apparatus 10 can be coupled directly to top edge 44 of side walls 46 of tank 19.

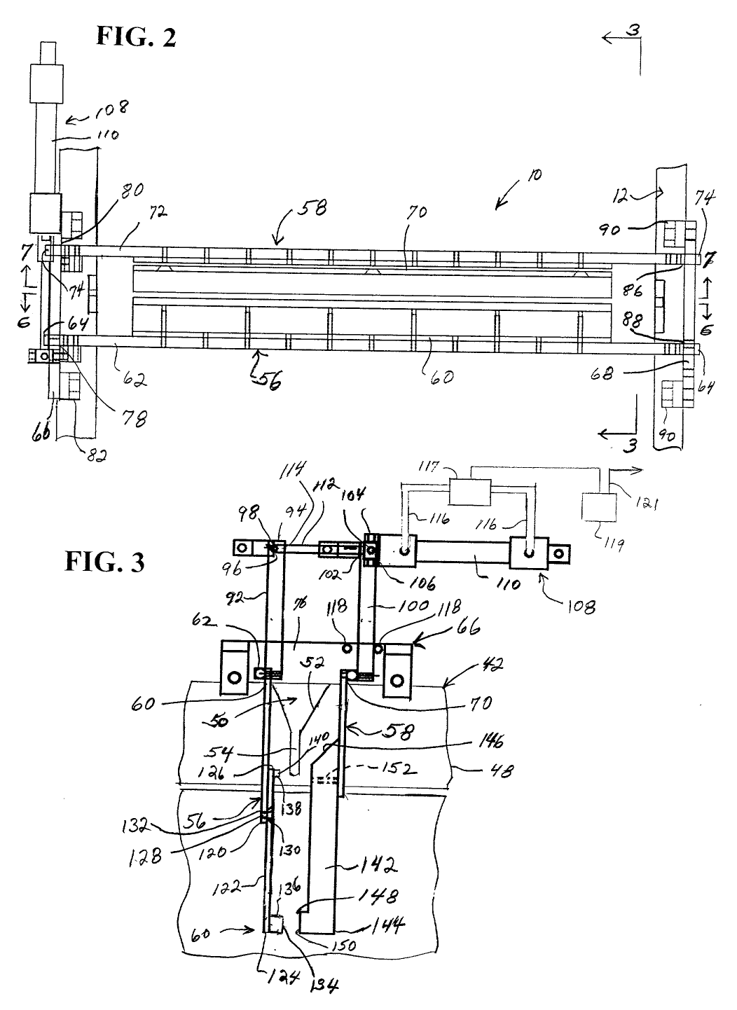

Referring to FIGS. 2 and 3, apparatus 10 includes a first operating arm 56 and a second operating arm 58 that are spaced apart a distance to receive gel clamp 18 therebetween. First arm 56 has a top end 60 connected to a support rod 62. Support rod 62 has outer ends 64 that are pivotally connected to a first end member 66 and a second end member 68. Second arm 58 has a top end 70 connected to a supporting rod 72 having outer ends 74. Outer ends 74 of support rod 72 are pivotally connected to first end member 66 and second end member 68.

First end member 66 is substantially parallel to second end member 68. First arm 56 is substantially parallel to second arm 58 to form a substantially rectangular shaped structure. First end member 66 has a plate 76 having spaced apart apertures 78 and 80 to receive end 64 of support rod 62 and end 74 of support rod 72, respectively. A coupling member 82 is provided at each longitudinal end of first end member 66 for coupling first end member 66 to a respective side rail 48 of frame 42. Second end member 68 is substantially a mirror image of first end member 66 and includes a plate 84 having spaced apart apertures 86 and 88 and a coupling member 90 at its longitudinal ends. Apertures 86 and 88 receive the end 64 of support rod 62 and the end 74 of support rod 72, respectively, for allowing pivotal movement of first arm 56 and second arm 58 with respect to end members 66 and 68.

Referring to FIG. 3, support rod 62 includes an upwardly extending connecting arm 92 adjacent first end member 66. Connecting arm 92 has a top end 94 with an aperture 96 for receiving a connecting pin 98. As shown in FIG. 3, connecting arm 92 is oriented substantially parallel to the plane of first arm 56. Support rod 72 includes a connecting arm 100 extending in an upward direction. Connecting arm 100 includes a top end 102 having an aperture 104 for receiving a pin 106.

An actuator 108 is coupled to connecting arm 92 and connecting arm 100 to pivot first arm 66 and second arm 58. In the embodiment illustrated, actuator 108 includes a pneumatic cylinder 110 having a reciprocating piston connected to a rod 112. Pneumatic cylinder 110 is pivotally connected to connecting arm 100 by pin 106. Rod 112 has an outer end 114 connected to connecting arm 92 by pin 98. Pneumatic cylinder 110 is connected to a pressure source by lines 116 to reciprocate rod 112 with respect to cylinder 110 to pivot connecting arms 92 and 100 for pivoting first arm 56 and second arm 58. Pressure lines 116 are coupled to a suitable pressure source such as a pump 117. A microprocessor or a computer 119 controls and actuates pump 117 in selected sequences and times to operate assembly 10. Computer 119 is also connected to robotic arm 15 by a connection 121 to coordinate the movement of robotic arm 15 and the location of the gel clamp and its associated gel with the operation of assembly 10. In alternative embodiments. Actuator 108 can be a hydraulically operated, solenoid operated or electrically operated device or other suitable device for actuating the apparatus.

As shown in FIGS. 4 and 5, apparatus 10 is positioned on top of tank 19, and gel clamp 18 is positioned between first arm 56 and second arm 58 so that gel 14 is suspended in the treating liquid 40. The treating liquid 40 can cause gel 14 to exhibit some shrinking or expansion, which can cause gel 14 to distort and twist when gel clamp 18 does not allow gel 14 to move. In this embodiment of the invention, pneumatic cylinder 110 is actuated to pivot first arm 56 and second arm 58 apart from each other so that gel clamp 18 can be lowered by robotic arm 15 into position in tank 12. Gel clamp 18 is lowered into tank 12 and supported in slots 54 between arms 56 and 58 of apparatus 10. Pneumatic cylinder 110 is then actuated to pivot first arm 56 and second arm 58 toward each other so that the arms grip gel 14 below gel clamp 18 and engage gel clamp 18 to open the clamping jaws and allow gel 18 to expand or contract to its normal position. First arm 56 and second arm 58 are then pivoted outwardly to release gel 14 and gel clamp 20 so that gel clamp 20 again closes on gel 14.

Referring to FIG. 3, first end member 76 includes stop members 118 on each side of connecting arm 100 to limit the pivotal movement of connecting arm 100. Preferably, stop members 118 are oriented to limit the pivotal movement of second arm 58 to a substantially vertical orientation when pivoted inwardly toward first arm 56.

First clamping arm 56 has a lower end 120 opposite top end 60. A rocker arm 122 is connected to lower end 120 of first arm 56 in a manner to allow limited pivotal movement of rocker arm 122 with respect to first arm 56. Rocker arm 122 has a longitudinal length substantially equal to the length of first arm 56 with a bottom edge 124 and a top edge 126. Rocker arm 122 is pivotally connected to lower end 120 of first arm 56 by screws 128 or other suitable fastening members. Screws 128 extend through a respective aperture 130 in rocker arm 122 that are spaced from top edge 126. Screws are threaded into complementing apertures 132 in first arm 56. Preferably, apertures have a diameter slightly greater than the diameter of screws 128 to provide limited pivotal movement of rocker arm 122 with respect to first arm 156.

Bottom edge 124 of rocker arm 122 defines a gripping surface 134 for gripping gel 14. Preferably, a rib 136 extends along bottom edge 124 and extends outwardly from the plane of rocker arm 122. Rib 136 can be integrally formed with rocker arm 122 or a separate element coupled to rocker arm 122 by an adhesive or mechanical fastener. Top edge 126 of rocker arm 122 defines an actuating surface for engaging gel clamp 18. In one preferred embodiment, a rib 138 extends along top edge 126 of rocker arm 122 to define actuating surface 140.

In preferred embodiments, rib 136 and rib 138 extend the length of rocker arm 122. Rib 136 has a width sufficient to grip and support the gel 14. Typically, rib 136 extends outwardly from the face of rocker arm 122 a distance to enable rib 136 to grip gel 14 without rocker arm 122 interfering with gel clamp 16.

Second arm 58 in the embodiment illustrated has an actuating member 142 having a substantially planar configuration. Actuating member 142 has a bottom end 144 and a top end 146. Bottom end 144 defines a gripping surface 148 for gripping gel 14. In a preferred embodiment, bottom end 144 of actuating member 142 includes a rib 150 defining gripping surface 148. As shown in FIG. 3, rib 150 is aligned with rib 136 of rocker arm 122 for gripping opposite sides of gel 14. Preferably, rib 150 extends outwardly from the face of actuating member 142 a distance at least equal to the thickness of the clamping jaw 20 of gel clamp 18 to enable rib 150 to grip gel 14 without interference from gel clamp 18. Actuating member 142 can be coupled to second arm 58 by screws 152 or other fasteners. Alternatively, actuating member 142 and second arm 58 can be integrally formed as a one-piece unit. In one embodiment of the invention, gripping surfaces 134 and 148 include a textured surface, such as a fine grit sandpaper to provide a slip resistant surface.

In the illustrated embodiments, first arm 56 and arm 58 are mounted to pivot about a fixed pivot point. In other embodiments the arms are mounted to move in a substantially linear direction rather that in a pivotal motion. The actuating members and the operating arms are coupled to the support to reciprocate first arm 56 and second arm 58 toward each other in a linear motion.

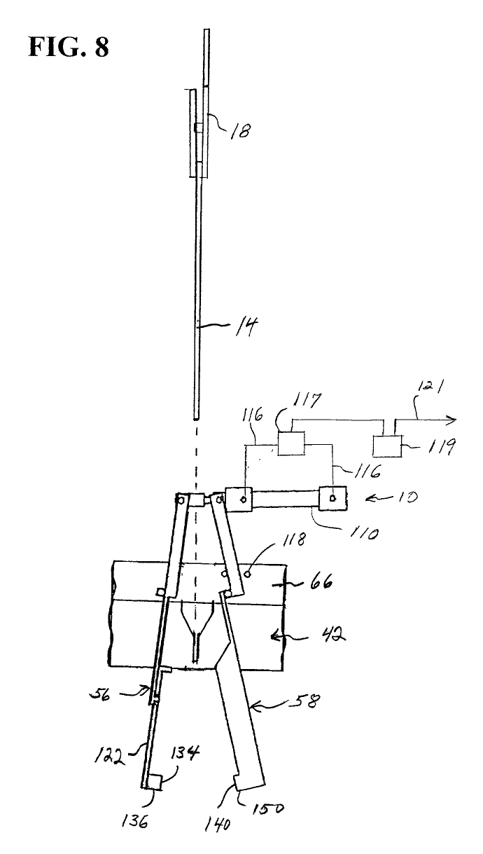

Referring FIGS. 8-12, the method of the invention for relieving tension in gel 14 is depicted. As shown in FIG. 8, pneumatic cylinder 110 is actuated to pivot first arm 56 and second arm 58 outwardly so that gel 14 and gel clamp 18 can be lowered into position between first arm 56 and second arm 58. In embodiments of the invention, gel clamp 18 is maneuvered by robotic arm 15, which is capable of moving and transporting gel 14 and gel clamp to various work stations.

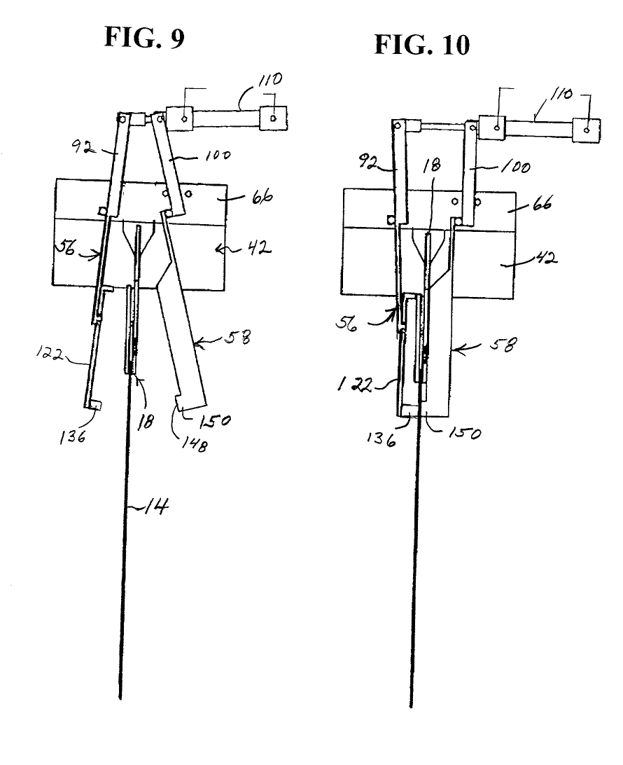

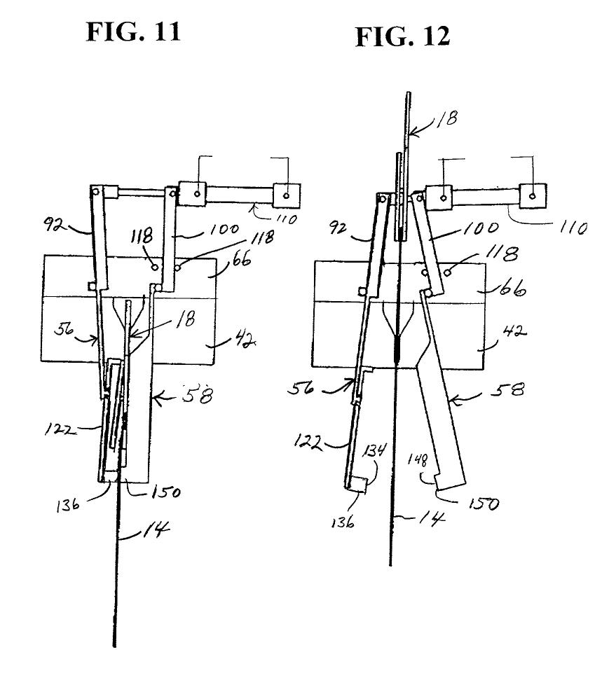

Gel clamp 18 is lowered into position onto support frame 42 of tank 19 as shown in FIG. 9. Pneumatic cylinder 110 is actuated to pivot first arm 56 and second arm 58 toward each other so that gripping surfaces 134 and 148 contact opposite sides of gel 14 with sufficient pressure to grip gel 14. As shown in FIG. 10, second arm 58 is in a substantially vertical orientation with connecting arm 100 engaging stop member 118. Further actuation of pneumatic cylinder 110 continues to pivot first arm 56 toward second arm 58 into engagement with gel clamp 18 in the position shown in FIG. 11.

The pivotal movement of first arm 56 enables rocker arm 122 to pivot with respect to first arm 56 so that actuating surface 140 engages a top end of clamping jaw 22 to pivot clamping jaw 22 about fulcrum 36 with respect to first clamping jaw 20, thereby separating the gripping surfaces of gel clamp 18 from gel 14. In this position, gripping surface 134 of first arm 56 and gripping surface 148 of second arm 58 hold gel 14 in position until the clamping jaws of gel clamp 18 are again closed to grip gel 14. As shown in FIG. 11, rib 136 extends from rocker arm 122 a distance sufficient to allow limited pivotal movement of clamping jaw 22 of gel clamp 18, thereby allowing gel clamp 18 to open. The method steps can be repeated several times as necessary to relieve stresses with respect to gel clamp 18 that is caused by contraction or expansion of gel 14. As shown in FIG. 12, pneumatic cylinder 110 is again actuated to separate first arm 56 and second arm 58 to enable gel clamp 18 and gel 14 to be removed from assembly 10.

In preferred embodiments, gel clamp 18 is lowered into position on frame 42 by robotic arm 15 and released by robotic arm 15 during the operation of apparatus 10. In an alternative embodiment, apparatus 10 can be positioned directly on tank 19 and gel clamp 18 can be supported by robotic arm 15 between arm 56 and arm 58 of apparatus 10.

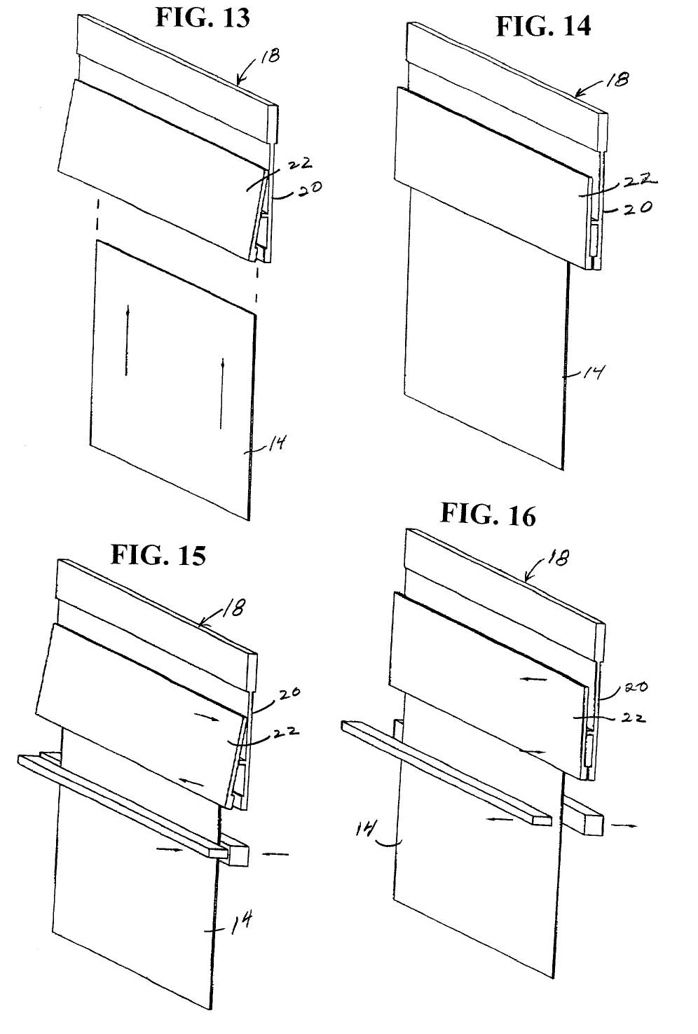

FIGS. 13-16 schematically illustrate the method of supporting gel 14 while opening the clamping jaws of jaw clamp 18. FIGS. 13 and 14 illustrate gel clamp 18 and supporting gel 14 during normal use and handling of gel 14. FIG. 15 schematically illustrates gripping surfaces 134 and 148 of first arm 56 and second arm 58 to secure and support gel 14 while the clamping jaws of gel clamp 18 are open. FIG. 16 shows gel clamp 18 closed to grip gel 14 and the separation of gripping surfaces 134 and 148 of first arm 56 and second arm 58.

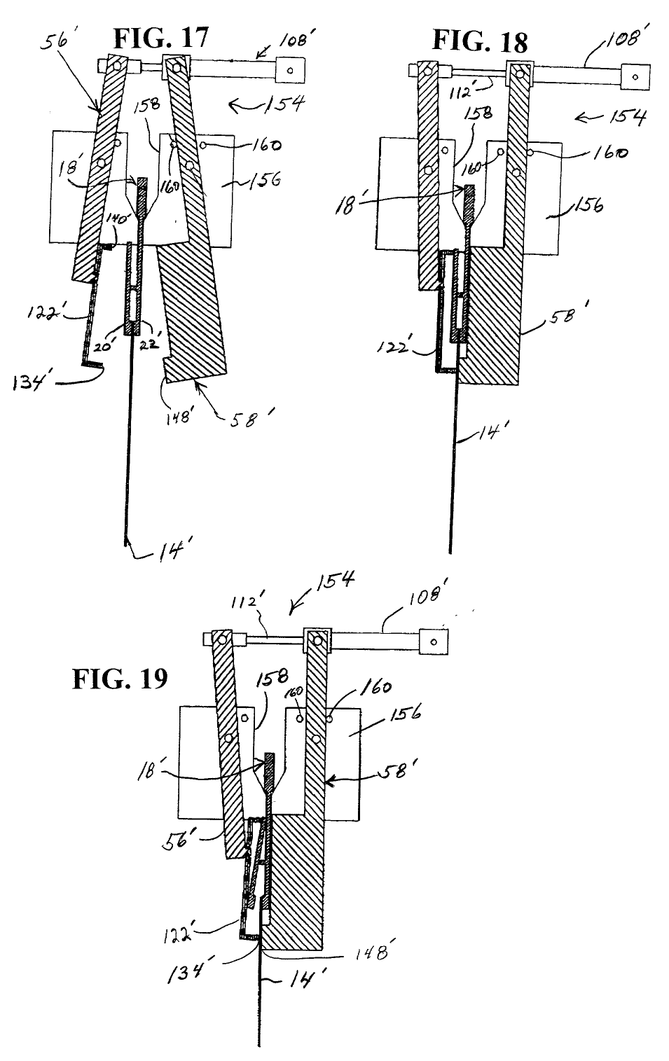

FIGS. 17-19 illustrate a second embodiment of the apparatus for relieving tension in a gel. Apparatus 154 is substantially identical to the first embodiment so that identical elements are identified by the same reference number with the addition of a prime. In the embodiment of FIGS. 17-19, apparatus 154 includes an end member 156 having first arm 56′ and second arm 58′ coupled thereto. In this embodiment, end member 156 includes a recess 158 for receiving and supporting a gel clamp 18′. As in the previous embodiment, a second end member (not shown) is provided to support the opposite end of first arm 56′ and second arm 58′. End member 156 includes a stop member 160 to limit pivotal movement of first arm 66′ with respect to end member 156.

The operation of apparatus 154 is substantially identical to the operation of apparatus 10 of the first embodiment. As shown in FIG. 17, a gel clamp 18′ is positioned in recess 158 of end member 156. Actuator 108′ is actuated to pivot first arm 56′ and second arm 58′ to the position shown in FIG. 18 where gripping surfaces 134′ and 148′ of first arm 56′ and second arm 58′ grip gel 14′. First arm 56′ is then pivoted to the position shown in FIG. 19 where actuating surface 140′ of rocker arm 122′ engages gel clamp 18 and opens clamping jaws 20′ and 22′. Actuator 108′ then pivots arms 56′ and 58′ outwardly with respect to each other to release gel clamp 18′ and gel 14′.

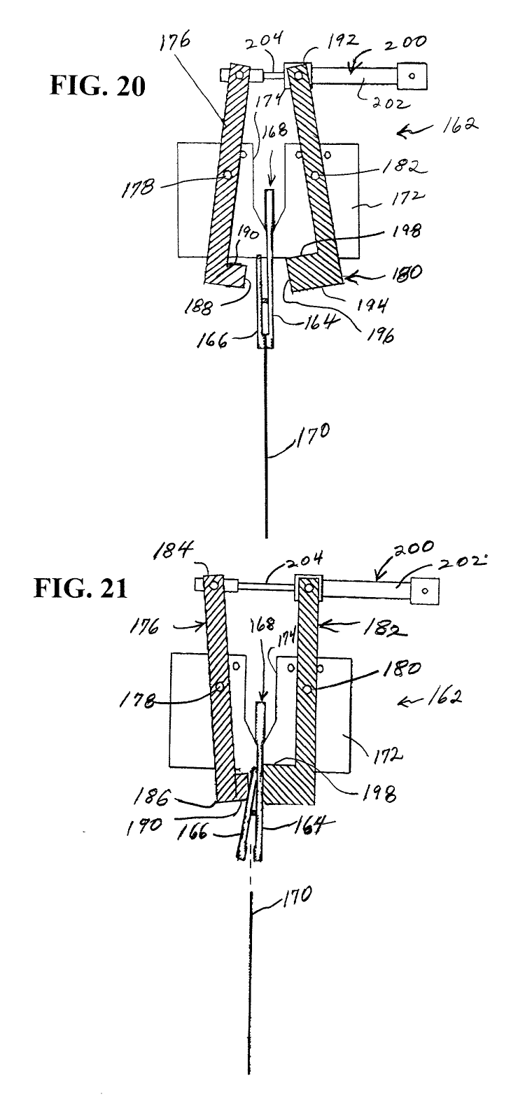

FIGS. 20 and 21 show another embodiment of the invention where an actuating assembly 162 is constructed to open clamping jaws 164 and 166 of a gel clamp 168 to separate gel 170 completely from gel clamp 168 after processing gel 170.

Referring to FIG. 20, assembly 162 includes opposite end members 172 having a recess 174 for receiving gel clamp 168. Gel clamp 168 is substantially identical to the gel clamp of the previous embodiment. A first arm 176 is pivotally connected to end members 172 by a pin 178. A second arm 180 is also pivotally connected to end members 172 by a pin 182. First arm 176 has a top end 184 and a lower end 186. Lower end 186 defines an actuating surface 188 for actuating gel clamp 168. In the embodiment illustrated, lower end 186 of first jaw 176 includes a rib 190 defining actuating surface 188.

Second arm 180 includes a top end 192 and a lower end 194 opposing first arm 176. Lower end 194 defines an actuating surface 196. As shown in FIG. 20, lower end 194 of second arm 180 includes a rib 198 defining actuating surface 196. Top end 184 of first arm 176 and top end 192 of second arm 180 are operatively coupled to an actuator 200. Actuator 200 in this embodiment is a pneumatic cylinder 202 connected to second arm 180. Pneumatic cylinder 202 includes a reciprocating piston rod 204 connected to first arm 176.

Actuating surface 188 of first arm 176 and actuating surface 196 of second arm 180 are oriented to engage the clamping jaws of gel clamp 168. Actuator 200 is operated to pivot first arm 176 and second arm 180 so that actuating surfaces 188 and 196 engage gel clamp 168 with sufficient force to open the clamping jaws allowing gel 170 to fall from gel clamp 168 to a suitable waste receptacle. Gel clamp 168 can then be reused with a new gel for processing.

The apparatus of the invention is primarily used in conjunction with an automated assembly for manipulating an electrophoresis gel between various workstations. The apparatus is particularly suitable for use in computer controlled systems where a computer monitors the movement of an electrophoresis gel throughout the various processing steps. The actuating member for operating the assembly is connected to and controlled by a main computer or microprocessor for coordinating the movement of the operating arms with the manipulation of the electrophoresis gel and the gel clamp. In this manner, the movement of the arms for engaging the gel and the gel clamp are coordinated with the robotic assembly for moving the gel between the workstations.

In the illustrated embodiments, the apparatus includes two arms that are pivoted toward each other in a manner to grip and support the gel while the clamping jaws are opened. In another embodiment one of the arms can be mounted in a fixed position with one arm being movable toward the fixed arm. Alternatively, one or both arms can be mounted for linear movement, such as by sliding on a track by a suitable actuator instead of pivotal movement of the illustrated embodiments. In one embodiment a single movable arm can be mounted to cooperated with a side wall of the treating tank. The movable arm can press the gel slab and the gel clamp against the wall of the tank to support the gel and to open the clamp for a time sufficient to enable the gel to relax and the wrinkles in the gel to flatten out.

While several embodiments of the invention have been illustrated, it will be appreciated that various changes and modifications can be made without departing from the scope of the invention as defined in the appended claims.

What is claimed is:

1. An apparatus for releasing an electrophoresis gel from a gel clamp, said gel clamp having a first clamping jaw and a second clamping jaw, said second clamping jaw being pivotal with respect to said first clamping jaw for clamping said gel between said first clamping jaw and said second clamping jaw, said apparatus comprising:
a first operating arm having an actuating area for engaging said first clamping jaw of said gel clamp; and
a second operating arm having an actuating area for engaging said second clamping jaw of said gel clamp, said first operating arm being movable with respect to said second operating arm between a disengaged position and an actuating position to open said first clamping jaw and said second clamping jaw to release said

2. The apparatus of claim 1, wherein said first operating arm and said second operating arm engage said clamp to enable said gel to fall from said gel clamp and said apparatus.

3. The apparatus of claim 1, further comprising a support for supporting said gel clamp between said first operating arm and said second operating arm.

4. The apparatus of claim 1, further comprising a robotic arm for supporting said gel clamp between said first operating arm and said second operating arm.

5. The apparatus of claim 3, wherein said first operating arm and said second operating arm are coupled to said support.

6. The apparatus of claim 1, wherein said first operating arm is pivotally mounted for reciprocating movement toward said second operating arm.

7. The apparatus of claim 1, wherein said apparatus further comprises a first end member and a second end member, and wherein said first operating arm and said second operating arm each have a first end coupled to said first end member, and said first operating arm and said second operating arm each have a second end coupled to said second end member.

8. The apparatus of claim 7, wherein first operating arm and second operating arm are pivotally coupled to said first end member and to said second end member.

9. The apparatus of claim 8, said apparatus further comprising a support for supporting said gel clamp between said first operating arm and said second operating arm.

10. The apparatus of claim 9, wherein said support is positioned below said first end member and said second end member.

11. The apparatus of claim 10, wherein said first end member and said second end member are removably coupled to said support.

12. The apparatus of claim 9, wherein said support includes a first rail and a second rail, each of said first rail and said second rail having a recess for receiving said gel clamp and supporting said gel clamp between said first operating arm and said second operating arm.

13. The apparatus of claim 1, further comprising an actuating member to move said first operating arm with respect to said second operating arm.

14. The apparatus of claim 13, wherein said actuating member is a pneumatic piston and cylinder assembly coupled to said first operating arm and said second operating arm.

15. The apparatus of claim 1, further comprising a tank dimensioned to receive said electrophoresis gel, wherein said first operating arm and said second operating arm are positioned at a top end of said tank.

16. The apparatus of claim 15, further comprising a support positioned at said top end of said tank, said support having a first end member and a second end member, said first operating arm and said second operating arm being coupled to said support.

17. The apparatus of claim 16, wherein said first operating arm has a first end coupled to said first end member and a second end coupled to said second end member, and said second operating arm has a first end coupled to said first end member and a second end coupled to said second end member.

18. The apparatus of claim 17, wherein said first end member includes a first recess and said second end member includes a second recess, said first recess and said second recess being positioned between said first operating arm and second operating arm and being oriented to support said electrophoresis gel.

19. The apparatus of claim 18, wherein said first recess and said second recess are oriented to receive a respective end of said gel clamp.

20. The apparatus of claim 19, wherein said first recess and second recess each have a substantially V-shaped portion.

21. The apparatus of claim 20, wherein said first recess and second recess further include a slot at an apex of said V-shaped portion, said slot being dimensioned to receive said gel clamp.

22. The apparatus of claim 1, wherein said first operating arm includes an upper end and a lower end, said lower end defining a gel gripping area, and wherein said actuating area is positioned at said upper end of said first operating arm.

23. The apparatus of claim 22, wherein said first operating arm includes an actuating rib defining said actuating area for actuating said gel clamp.

24. The apparatus of claim 23, wherein said lower end of said first operating arm includes a rib defining said gripping area.

25. The apparatus of claim 24, wherein said second operating arm has an upper end and a lower end, said lower end defining a gel gripping surface, and where said actuating area is positioned at said upper end.

26. The apparatus of claim 25, wherein said second operating arm includes a rib defining said gel gripping surface.

27. The apparatus of claim 1, further comprising a rocker arm pivotally coupled to said first operating arm, said rocker arm being pivotal between a disengaging position and an actuating position.

28. The apparatus of claim 27, wherein said second operating arm has a lower end with a rib defining a gel gripping surface.

29. The apparatus of claim 27, wherein said rocker arm has a first end defining a gel gripping surface and a second end defining said actuating area of said first operating arm.

30. The apparatus of claim 28, wherein said gripping surface of said rocker arm and said gripping surface of said second operating arm are oriented to grip said gel, and said actuating areas are oriented to engage and open said gel clamp when said second operating arm is in said actuating position, thereby supporting said gel between said gripping surfaces, opening said first clamping jaw and said second clamping jaw, and relieving stresses on said gel between said first clamping jaw and said second clamping jaw.

31. An apparatus for relieving tension in an electrophoresis gel supported by a gel clamp, said gel clamp having a first clamping jaw and a second clamping jaw, said apparatus comprising:
a first movable operating arm having a gripping surface and an actuating surface; and
a second operating arm opposing said first operating arm and having a gripping surface and an actuating surface;
said first operating arm being movable with respect to said second operating arm between a disengaging position spaced from said gel and gel clamp and a clamping position, wherein said gripping surfaces of said first operating arm and said second operating arm grip said gel, and wherein said actuating surfaces engage said gel clamp to open said first clamping jaw and said second clamping jaw to release said gel.

32. The apparatus of claim 31, further comprising a support member to support said gel clamp between said first operating arm and said second operating arm.

33. The apparatus of claim 32, wherein said first operating arm and said second operating arm are coupled to said support.

34. The apparatus of claim 31, wherein said apparatus further comprises a first end member coupled to said first operating arm and said second operating arm, and a second end member coupled to said first operating arm and said second operating arm.

35. The apparatus of claim 34, wherein said first operating arm is pivotally coupled to said first end member and said second end member, and wherein said second operating arm is pivotally coupled to said first end member and said second end member.

36. The apparatus of claim 35, further comprising a support member for supporting said gel clamp between said first operating arm and said second operating arm, and wherein said first end member and said second end member are supported by said support member.

37. The apparatus of claim 31, further comprising an actuator operatively connected to said first operating arm and said second operating arm to move said operating arms between said disengaged position and said clamping position.

38. The apparatus of claim 31, wherein said first operating arm includes a rocker arm pivotally coupled thereto, said rocker arm having a first end defining said gripping end and a second end defining said actuating end.

39. The apparatus of claim 38, wherein said first end of said rocker arm includes a first rib defining said gripping surface.

40. The apparatus of claim 39, wherein said first rib extends outwardly from a plane of said rocker arm.

41. The apparatus of claim 40, wherein said second end of said rocker arm includes a second rib extending outwardly from said plane of said rocker arm and substantially parallel to said first rib.

42. The apparatus of claim 31, wherein said gripping surface of said first operating arm and said gripping surface of said second operating arm have a length sufficient to grip and suspend said gel in a vertical orientation.

43. A method for relieving tension in an electrophoresis gel suspended by a gel clamp, said gel clamp having a first clamping jaw and a second clamping jaw, said method comprising the steps of:
gripping said electrophoresis gel with a gel handling assembly to apply sufficient force to suspend said gel in a vertical orientation,
opening said gel clamp for a time sufficient to relieve tension in said gel while gripping and suspending said gel by said gel handling assembly,
closing said gel clamp onto said gel, and
releasing said gel from said gel handling assembly.

44. The method of claim 43, wherein said gel handling assembly comprises a first movable operating arm having a gripping surface and an actuating surface, and a second movable operating arm opposing said first operating arm and having a gripping surface and an actuating surface, said method comprising moving said first operating arm with respect to said second operating arm, whereby said gripping surfaces contact said gel and grip said gel before said actuating surfaces contact said gel clamp and open said gel clamp.

45. The method of claim 44, wherein said first operating arm includes a rocker arm having a first end defining said gripping surface and a second end defining said actuating surface.

46. A method of processing an electrophoresis gel comprising the steps of:
suspending said gel by a gel clamp, said gel clamp having a first clamping jaw and a second clamping jaw, said gel being clamped between respective clamping surfaces of said first clamping jaw and said second clamping jaw;
contacting said gel with at least one treating liquid,
gripping said gel with a gel handling assembly with sufficient force to suspend said gel in a vertical orientation,
opening said first and second clamping jaws of said gel clamp while suspending said gel by said gel handling assembly for sufficient time to relieve tension in said gel caused by shrinking or expansion of said gel,
closing said first and second clamping jaws of said gel clamp to grip said gel, and
releasing said gel from said gel handling assembly.

47. The method of claim 46, wherein said treating liquid is a staining reagent and said method further comprises staining said gel.

48. The method of claim 46, wherein said treating liquid is contained in a tank having a dimension to receive said gel in said vertical orientation.

49. The method of claim 48, comprising providing a support positioned above said tank and positioning said gel clamp on said support.

50. The method of claim 48, wherein said gel handling assembly is positioned above said tank.

51. The method of claim 50, wherein said gel handling assembly comprises a first movable operating arm and a second operating arm, said method comprising moving said first operating arm with respect to said second operating arm and gripping said gel.

52. The method of claim 51, wherein said first operating arm and said second operating arm are pivotally coupled to a first end member and to a second end member.

53. The method of claim 51, wherein said first operating arm includes a first end having a gripping surface for gripping said gel and a second end having an actuating surface for contacting said gel clamp, and said second operating arm includes a first end having a gripping surface and a second end having an actuating surface, said method comprising bringing said first and second operating arms into contact with said gel and said gel clamp.

54. The method of claim 53, wherein said first arm includes a rocker arm having a first end defining said gripping surface and a second end defining said actuating surface.

55. The method of claim 46, further comprising a robotic arm for coupling to said gel clamp, said method comprising supporting said gel and said gel clamp by said robotic arm in said gel handling assembly.
